(19) United States
(12) Patent Application Publication
(10) Pub. No.: US 2024/0298133 A1
(43) Pub. Date: Sep. 5, 2024

(54) Apparatus, Methods and Computer Programs for Training Machine Learning Models

(71) Applicant: Nokia Technologies Oy, Espoo (FI)

(72) Inventors: Juha Tapio Vilkamo, Helsinki (FI); Mikko Johannes HONKALA, Espoo (FI)

(21) Appl. No.: 18/571,326

(22) PCT Filed: May 24, 2022
(86) PCT No.: PCT/FI2022/050357

§ 371 Date: Dec. 18, 2023

(30) Foreign Application Priority Data
Jun. 17, 2021 (GB) 2108641.8

(51) Int. Cl. H04S 7/00; G06N 3/08; H04R 3/00; H04R 5/027

(52) U.S. Cl. CPC H04S 7/302; G06N 3/08; H04R 3/005; H04R 5/027; H04S 2400/11; H04S 2400/15; H04S 2420/03; H04S 2420/07

(57) ABSTRACT

An apparatus includes circuitry for training a machine learning model such as a neural network to estimate spatial metadata for a spatial sound distribution. The apparatus includes circuitry for obtaining first capture data for a machine learning model where the first capture data is related to a plurality of spatial sound distributions and where the first capture data relates to a target device configured to obtain at least two microphone signals. The apparatus also includes circuitry for obtaining second capture data for the machine learning model where the second capture data is obtained using the same spatial sound distributions and where the data includes information indicative of spatial properties of the spatial sound distributions and the data is obtained using a reference capture method. The apparatus also includes circuitry for training the machine learning model to estimate the second capture data based on the first capture data.

### TECHNOLOGICAL FIELD

Examples of the disclosure relate to apparatus, methods and computer programs for training machine learning models. Some relate to apparatus, methods and computer programs for training machine learning models for use in capturing spatial audio.

### BACKGROUND

Spatial audio enables spatial properties of a sound scene to be reproduced for a user so that the user can perceive the spatial properties. In order to enable the spatial properties to be reproduced spatial parameters of the sound scene need to be obtained and provided in a format that can be used to enable rendering of the spatial audio.

### BRIEF SUMMARY

According to various, but not necessarily all examples of the disclosure, there is provided an apparatus comprising means for:
obtaining first capture data for a machine learning model where the first capture data is related to a plurality of spatial sound distributions and where the first capture data relates to a target device configured to obtain at least two microphone signals;
obtaining second capture data for the machine learning model where the second capture data is obtained using the same plurality of spatial sound distributions and where the second capture data comprises information indicative of spatial properties of the plurality of spatial sound distributions and the second capture data is obtained using a reference capture method; and
training the machine learning model to estimate the second capture data based on the first capture data.

The machine learning model may be trained for use in processing microphone signals obtained by the target device.

The machine learning model may comprise a neural network.

The spatial sound distributions may comprise a sound scene comprising a plurality of sound positions and corresponding audio signals for the plurality of sound positions.

The spatial sound distributions used to obtain the first capture data and the second capture data may comprise virtual sound distributions.

The spatial sound distributions may be produced by two or more loudspeakers.

The spatial sound distributions may comprise a parametric representation of a sound scene.

The information indicative of spatial properties of the plurality of spatial sound distributions is obtained in a plurality of frequency bands.

Obtaining the first capture data may comprise:
obtaining information relating to a microphone array of the target device; and
using the information relating to the microphone array to process a plurality of spatial sound distributions to obtain first capture data.

The means may be for processing the first capture data into a format that is suitable for use as an input to the machine learning model.

Obtaining the second capture data may comprise using the one or more spatial sound distributions and a reference microphone array to determine reference spatial metadata for the one or more sound scenes

The machine learning model may be trained to provide spatial metadata as an output.

The spatial metadata may comprise, for one or more frequency sub-bands, information indicative of;
a sound direction, and
sound directionality.

The target device may comprise a mobile telephone.

According to various, but not necessarily all, examples of the disclosure there is provided an apparatus comprising at least one processor; and at least one memory including computer program code, the at least one memory and the computer program code configured to, with the at least one processor, cause the apparatus at least to perform:
obtaining first capture data for a machine learning model where the first capture data is related to a plurality of spatial sound distributions and where the first capture data relates to a target device configured to obtain at least two microphone signals;
obtaining second capture data for the machine learning model where the second capture data is obtained using the same plurality of spatial sound distributions and where the second capture data comprises information indicative of spatial properties of the plurality of spatial sound distributions and the second capture data is obtained using a reference capture method; and
training the machine learning model to estimate the second capture data based on the first capture data.

According to various, but not necessarily all, examples of the disclosure there is provided a method comprising:
obtaining first capture data for a machine learning model where the first capture data is related to a plurality of spatial sound distributions and where the first capture data relates to a target device configured to obtain at least two microphone signals;
obtaining second capture data for the machine learning model where the second capture data is obtained using the same plurality of spatial sound distributions and where the second capture data comprises information indicative of spatial properties of the plurality of spatial sound distributions and the second capture data is obtained using a reference capture method; and
training the machine learning model to estimate the second capture data based on the first capture data.

According to various, but not necessarily all, examples of the disclosure there is provided a computer program comprising computer program instructions that, when executed by processing circuitry, cause:
obtaining first capture data for a machine learning model where the first capture data is related to a plurality of spatial sound distributions and where the first capture data relates to a target device configured to obtain at least two microphone signals;
obtaining second capture data for the machine learning model where the second capture data is obtained using the same plurality of spatial sound distributions and where the second capture data comprises information indicative of spatial properties of the plurality of spatial sound distributions and the second capture data is obtained using a reference capture method; and
training the machine learning model to estimate the second capture data based on the first capture data.

### BRIEF DESCRIPTION

Some examples will now be described with reference to the accompanying drawings in which:

FIG. 1 shows an example apparatus;

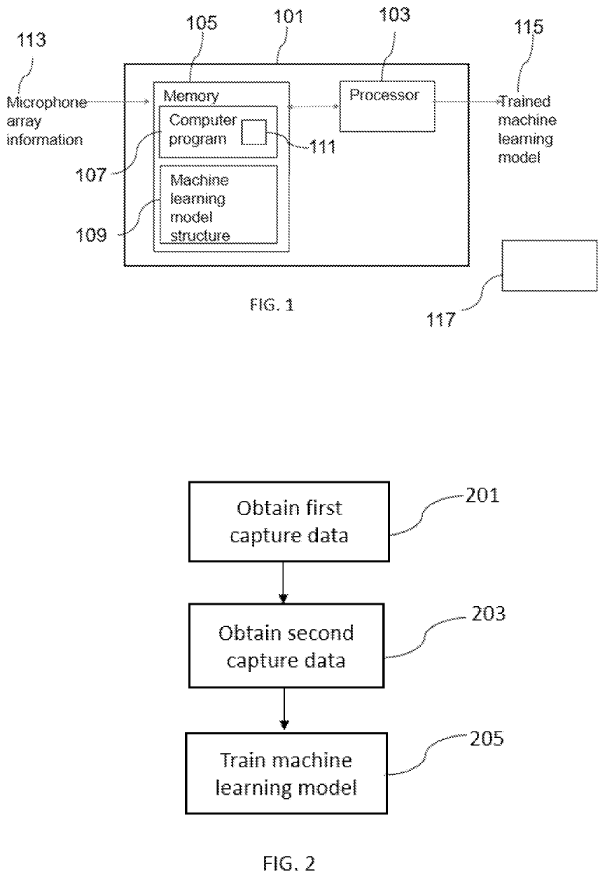

FIG. 2 shows an example method;

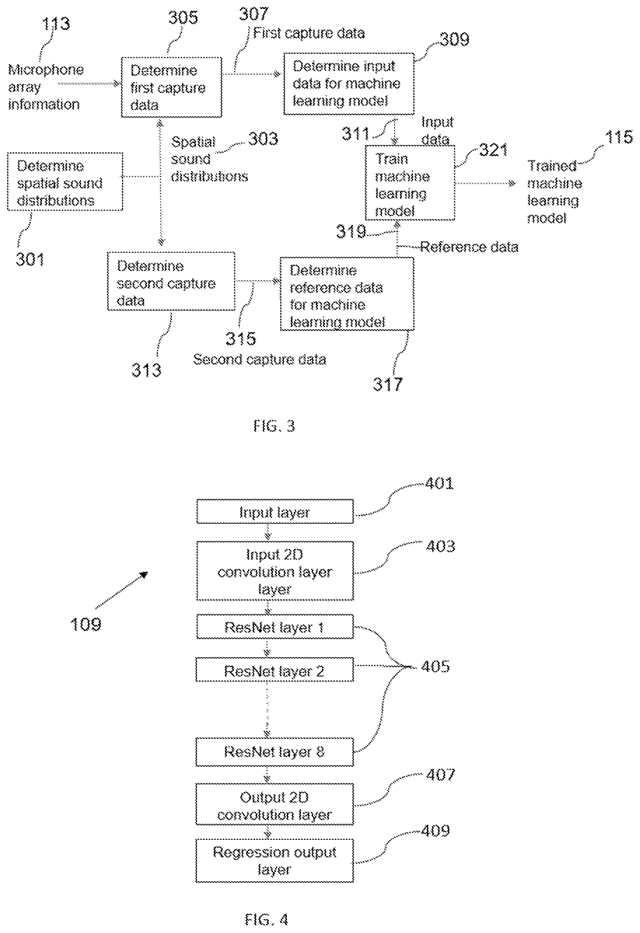

FIG. 3 shows an example method;

FIG. 4 shows an example machine learning model;

FIG. 5 shows sections of an example machine learning model architecture; and

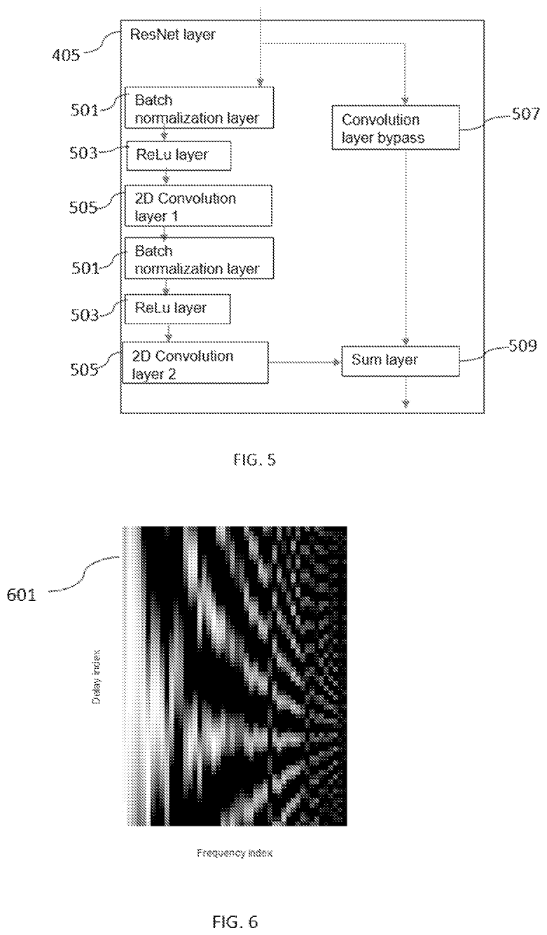

FIG. 6 shows data used in examples of the disclosure.

### DETAILED DESCRIPTION

Examples of the disclosure relate to training a machine learning model such as a neural network to estimate spatial metadata for a spatial sound distribution. The trained machine learning model can then be provided to target devices to enable determination of spatial metadata and as a result high quality spatial audio to be provided from target devices even where the target devices have a limited number and/or quality of microphones, and/or that the microphone positioning on the target device is unfavorable for spatial audio capturing.

FIG. 1 shows an example apparatus 101 that could be used to implement examples of the disclosure. In the example of FIG. 1 the apparatus 101 comprises at least one processor 103 and at least one memory 105. It is to be appreciated that the apparatus 101 could comprise additional components that are not shown in FIG. 1.

In the example of FIG. 1 the apparatus 101 comprises a processing apparatus. The apparatus 101 can be configured to train a machine learning model for use in a target device. The machine learning model can be trained to provide spatial metadata for audio signals captured by a microphone array associated with the target device.

The machine learning models can comprise neural networks or any other suitable models. In some examples the machine learning model can be implemented using a trainable computer program. The trainable computer program can comprise any program that can be trained to perform one or more tasks without being explicitly programmed to perform those tasks.

In the example of FIG. 1 the implementation of the apparatus 101 can be as processing circuitry. In some examples the apparatus 101 can be implemented in hardware alone, have certain aspects in software including firmware alone or can be a combination of hardware and software (including firmware).

As illustrated in FIG. 1 the apparatus 101 can be implemented using instructions that enable hardware functionality, for example, by using executable instructions of a computer program 107 in a general-purpose or special-purpose processor 103 that can be stored on a computer readable storage medium (disk, memory etc.) to be executed by such a processor 103.

The processor 103 is configured to read from and write to the memory 105. The processor 103 can also comprise an output interface via which data and/or commands are output by the processor 103 and an input interface via which data and/or commands are input to the processor 103.

The processor 103 can comprise a graphics processing unit (GPU) or a plurality of GPUs or any other processor 103 that is suitable for training machine learning models such as neural networks or any other suitable type of machine learning model.

The memory 105 is configured to store a computer program 107 comprising computer program instructions (computer program code 111) that controls the operation of the apparatus 101 when loaded into the processor 103. The computer program instructions, of the computer program 107, provide the logic and routines that enables the apparatus 101 to perform the methods illustrated in FIGS. 2 and 3. The processor 103 by reading the memory 105 is able to load and execute the computer program 107.

The memory 105 is also configured to store a machine learning model structure 109. in some examples the machine learning model can be a type of trainable computer program. Other programs could be used in other examples. The machine learning model could be a neural network or any other suitable type of machine learning model. The machine learning model structure 109 could comprise information relating to the type of machine learning model and parameters of the machine learning model such as the number of layers within the model, the number of nodes within the layers, the organization of the network layers and/or any other suitable parameters.

The apparatus 101 therefore comprises: at least one processor 103; and at least one memory 105 including computer program code 111, the at least one memory 105 and the computer program code 111 configured to, with the at least one processor 103, cause the apparatus 101 at least to perform:
obtaining first capture data for a machine learning model where the first capture data is related to a plurality of spatial sound distributions and where the first capture data relates to a target device configured to obtain at least two microphone signals;
obtaining second capture data for the machine learning model where the second capture data is obtained using the same plurality of spatial sound distributions and where the second capture data comprises information indicative of spatial properties of the plurality of spatial sound distributions and the second capture data is obtained using a reference capture method; and
training the machine learning model to estimate the second capture data based on the first capture data.

As illustrated in FIG. 1 the computer program 107 can arrive at the apparatus 101 via any suitable delivery mechanism 117. The delivery mechanism 117 can be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 107. The delivery mechanism can be a signal configured to reliably transfer the computer program 107. The apparatus 101 can propagate or transmit the computer program 107 as a computer data signal. In some examples the computer program 107 can be transmitted to the apparatus 101 using a wireless protocol such as Bluetooth, Bluetooth Low Energy, Bluetooth Smart, 6LoWPan (IPv6 over low power personal area networks) ZigBee, ANT+, near field communication (NFC), Radio frequency identification, wireless local area network (wireless LAN) or any other suitable protocol.

The computer program 107 comprises computer program instructions for causing an apparatus 107 to perform at least the following:
obtaining first capture data for a machine learning model where the first capture data is related to a plurality of spatial sound distributions and where the first capture data relates to a target device configured to obtain at least two microphone signals;
obtaining second capture data for the machine learning model where the second capture data is obtained using the same plurality of spatial sound distributions and where the second capture data comprises information indicative of spatial properties of the plurality of spatial sound distributions and the second capture data is obtained using a reference capture method; and
training the machine learning model to estimate the second capture data based on the first capture data.

The computer program instructions can be comprised in a computer program 107, a non-transitory computer readable medium, a computer program product, a machine readable medium. In some but not necessarily all examples, the computer program instructions can be distributed over more than one computer program 107.

Although the memory 105 is illustrated as a single component/circuitry it can be implemented as one or more separate components/circuitry some or all of which can be integrated/removable and/or can provide permanent/semi-permanent/dynamic/cached storage.

Although the processor 103 is illustrated as a single component/circuitry it can be implemented as one or more separate components/circuitry some or all of which can be integrated/removable. The processor 103 can be a single core or multi-core processor.

References to “computer-readable storage medium”, “computer program product”, “tangibly embodied computer program” etc. or a “controller”, “computer”, “processor” etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term “circuitry” can refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software might not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the FIGS. 2 and 3 can represent steps in a method and/or sections of code in the computer program 107. The illustration of a particular order to the blocks does not necessarily imply that there is a required or preferred order for the blocks and the order and arrangement of the block can be varied. Furthermore, it can be possible for some blocks to be omitted.

In examples of the disclosure the apparatus 101 can be configured to receive microphone array information 113. The microphone array information 113 comprises information relating to a microphone array of a target device. The microphone array information 113 could comprise information relating to the number of microphones, the relative positions of microphones, the types of microphones within the array, spatial responses (such as impulse responses, or transfer functions, or steering vectors) of the microphones, and/or any other suitable information.

The apparatus 101 is configured to use the microphone array information and machine learning model structure 109 to train the machine learning model for the target device associated with the microphone array. FIGS. 2 and 3 show example methods of training the machine learning model. The apparatus 101 is therefore configured to provide a trained machine learning model 115 as an output.

The trained machine learning model 115 can be provided to one or more target devices for use in capturing and rendering spatial audio. In some examples the trained machine learning model 115 can be provided to storage. The storage could be in a location that can be accessed by one or more target devices.

In the example of FIG. 1 the apparatus 101 is shown as a single entity. It is to be appreciated that in other examples the apparatus 101 could be provided a plurality of different entities that could be distributed within a cloud or other suitable network.

FIG. 2 shows an example method of training a machine learning model. The method could be implemented using an apparatus 101 as shown in FIG. 1 or by any other suitable means. The method shown in FIG. 2 enables a machine learning model to be trained for use in processing microphone signals obtained by a target device. The method of FIG. 2 can be performed by an apparatus that is separate to the target device. The trained machine learning model can then be provided to the target device and/or can be stored in a location that can be accessed by the target device. In some examples the machine learning model can be provided to a further device or a network of devices such as a cloud to which the target device can provide information based on the microphone signals of the target device.

The method comprises, at block 201, obtaining first capture data for a machine learning model.

In this description the term “spatial sound distribution” is used. A spatial sound distribution comprises information in any format that defines how sound is distributed in space, such as multiple signals or parameter sets. A non-exhaustive list of examples comprises: multi-loudspeaker signals, Ambisonic multi-channel signals, spatial covariance matrices (such as loudspeaker-domain or Ambisonic domain), and parametric representations of a sound scene. A parametric representation could for example be one that determines amounts of uncorrelated or correlated (sound) energy that is associated with different directions at different frequencies. A spatial covariance matrix could be for example a covariance matrix of an Ambisonic signal in a multitude of frequencies. In other words, the spatial sound distributions can define actual audio signals (in any format, e.g., time-domain, frequency domain, encoded) or they can otherwise define how the sound energy is distributed in space, and then would not contain any actual signal waveforms that could be converted to a listenable form. The purpose of these spatial sound distributions is to determine various sound scenes, or characteristics of various sound scenes, that could occur when a microphone arrangement would be capturing spatial sound.

The first capture data is related to a plurality of spatial sound distributions. The first capture data can represent what a microphone array of a target device would capture for given spatial sound distributions.

The spatial sound distributions can comprise a multi-channel signal that defines sounds at different directions. The multi-channel signal can be provided in any suitable format.

The spatial sound distributions can comprise sound scenes. Each of the sound scenes can comprise a plurality of sound positions and corresponding audio signals for the plurality of sound positions. The spatial sound distributions can comprise a parametric representation of a sound scene. In some examples the spatial sound distributions can comprise randomised sound sources (positions, levels and/or spectra) and ambience (spatial distributions, levels and/or spectra) configured to make complex sound scenes.

In some examples the spatial sound distributions can comprise virtual sound distributions. The virtual sound distributions can be generated using any suitable means.

In some examples the spatial sound distributions can comprise real sound distributions. The real sound distributions can be produced by two or more loudspeakers.

The first capture data is also related to the target device. The first capture data corresponds to the way that the target device would capture the spatial sound distributions.

The target device can be any device that is to be used to capture spatial audio. For example, the target device could be a user device such as a mobile telephone or other audio capture device. The target device is associated with a microphone array. The microphone array is configured to obtain at least two microphone signals. In some examples the microphone array can be provided within the target device, for example, two or more microphones can be provided within a user device such as a mobile telephone.

The microphone array can comprise any arrangement of microphones that can be configured to enable a spatial sound distribution to be captured. The microphone array can comprise one or more microphones that are positioned further away from other microphones and/or provided in another device to other microphones within the array. In examples of the disclosure the microphone array of the target device can be sub-optimal. For example, there may be limitations on the quality of the spatial information that can be obtained by the microphone array of the target device. This could be due to the positioning of the microphones, the number of the microphones, the type of microphones within the array, the shape of the target device, interference from the other components within the target device and/or any other relevant factors.

The first capture data can therefore represent what a target device would capture for a given spatial sound distribution.

At block 203 the method comprises obtaining second capture data for the machine learning model.

The second capture data is obtained using the same plurality of spatial sound distributions that are used to obtain the first capture data. The second capture data can be obtained using a reference capture method. For example, the reference capture method could use an idealised, or substantially idealised, microphone array. The idealised microphone array could be a higher quality microphone than the microphone array associated with the target device, or a simulation of a microphone array or spatial capturing having arbitrarily high spatial accuracy. In some examples the reference capture method can function without assuming any particular microphone array, and instead can determine the second capture data directly based on the spatial sound distributions. For example, where the spatial sound distributions comprise directional information (sound X at direction Y, and so forth), the reference capture data could determine directional parameters based on that information, without an assumption of any particular ideal or practical microphone arrangement. In another example, if the spatial sound distributions are in a form of Ambisonic spatial covariance matrices, then the reference capture method could derive the second capture data using known parameter estimation means suitable for Ambisonic input signals.

The second capture data comprises information indicative of spatial properties of the plurality of spatial sound distributions that is captured using a reference capture method. The information could comprise more accurate spatial information and/or more detailed spatial information or any other spatial information than would be obtained with the microphone array of the target device.

The information indicative of spatial properties of the plurality of spatial sound distributions can be obtained in a plurality of frequency bands. The information indicative of spatial properties of the plurality of spatial sound distributions can comprise, for one or more sub-bands information indicative of a sound direction and sound directionality. The sound directionality can be an indication of how directional or non-directional the sound is. The sound directionality can provide an indication of whether the sound is ambient sound or provided from point sources. The sound directionality can be provided as energy ratios of sounds from different directions, or vectors where the direction indicates the sound direction and the length indicates the directionality, or in any other suitable format.

The second capture data can therefore represent the spatial metadata that could be captured by an ideal, or substantially ideal, (real or virtual) microphone array for a given spatial sound distribution, or by any other suitable reference capture method. This can be referred to as reference spatial metadata.

At block 303 the method comprises training the machine learning model to estimate the second capture data based on the first capture data. The machine learning model can be trained to estimate the reference spatial metadata based on first capture data that represents a spatial sound scene captured by a sub-optimal microphone array. The accuracy of the estimation may depend on the properties of the microphone array.

The machine learning model can comprise any structure that enables a processor 103 to provide an output of spatial metadata based on an input comprising first capture data. The machine learning model can comprise a neural network or any other suitable type of trainable model. The term “Machine Learning Model” refers to any kind of artificial intelligence (AI), intelligent or other method that is trainable or tuneable using data. The machine learning model can comprise a computer program. The machine learning model can be trained to perform a task, such as estimating spatial metadata, without being explicitly programmed to perform that task. The machine learning model can be configured to learn from experience E with respect to some class of tasks T and performance measure P if its performance at tasks in T, as measured by P, improves with experience E. in these examples the machine learning model can often learn from the reference data 319 to make estimations on future data. The machine learning model can be also a trainable computer program. Other types of machine learning models could be used in other examples.

It is also possible to train one machine learning model with specific architecture, then derive another machine learning model from that using processes such as compilation, pruning, quantization or distillation. The term “Machine Learning Model” covers also all these use cases and the outputs of them. The machine learning model can be executed using any suitable apparatus, for example CPU, GPU, ASIC, FPGA, compute-in-memory, analog, or digital, or optical apparatus. It is also possible to execute the machine learning model in apparatus that combine features from any number of these, for instance digital-optical or analog-digital hybrids. In some examples the weights and required computations in these systems can be programmed to correspond to the machine learning model. In some examples the apparatus can be designed and manufactured so as to perform the task defined by the machine learning model so that the apparatus is configured to perform the task when it is manufactured without the apparatus being programmable as such.

The spatial metadata that is provided by the trained machine learning model can be used for rendering, or otherwise processing, spatial audio signals.

The spatial metadata that is output by the machine learning model can be provided in any suitable format. In some examples the output of the machine learning model can be processed into a different format before it is used for rending spatial audio signals. For example, the output of the machine learning model could be one or more vectors and these vectors could then be converted into a format that can be associated with the spatial audio signals for use in rendering, or otherwise processing, audio signals. For example the vectors could be converted into a direction parameter and a directionality parameter for different frequency subbands.

FIG. 3 shows an example method according to examples of the disclosure. The method could be implemented using an apparatus 101 as shown in FIG. 1 or by any other suitable means.

At block 301 the method comprises determining spatial sound distributions. The spatial sound distributions can comprise virtual sound distributions, real sound distributions or a mix of real and virtual sound distributions.

It is to be appreciated that the spatial sound distributions can be defined in different ways. Different ways of defining the spatial sound distributions can comprise how a set of signals is distributed in different directions, or how the sound energy (without defining actual signal sequences) is distributed in different directions. The spatial sound distribution can be defined in various formats, such as direction-specific formats (such as sound X at direction Y) or in other spatial formats, such as in a spherical harmonic format, or any other suitable format.

In some examples spatial sound distributions can comprise sound scenes and each of the sound scenes can comprise a plurality of sound positions and corresponding audio signals for the plurality of sound positions.

As another example, the spatial sound distributions can comprise parametric representations of sound scenes. For example, a spatial sound distribution can define the amount of incoherent or coherent sound energy at different frequencies and at different directions.

In examples where the spatial sound distribution comprises a virtual sound distribution then suitable virtual sound scenes could be used. In some examples the virtual sound scenes could comprise a 2048 sample burst of processed pink noise sequences reproduced with a virtual set of loudspeakers. The virtual set of loudspeakers could be 36 or more virtual loudspeakers spaced at regular intervals on a horizontal plane. A reproduction by virtual loudspeaker can be realized as follows:

First, the responses from actual loudspeakers at different directions to a target device with the microphones are measured.

Second, the audio signal sequences corresponding to different directions are convolved with the corresponding responses, and the results are added together to form the virtually captured microphone audio signals.

In some examples the target device directional responses can be obtained by simulations instead of measurements.

Any suitable process can be used to generate a single virtual sound scene. An example process comprises:
Randomizing one or more simultaneous sound source directions
Randomizing a direction value between-90 and 90 degrees for each of those directions
Randomizing a direct-to-total energy ratio value for each of those directions, so that their sum does not exceed one
Formulating ambience-to-total ratio value, which is (1−(sum of direct to total ratios))
For each direct source:
   Generating a 2048 sample pink noise sequence, windowing it with a square-root Hanning window, and transforming it with FFT to 1025 unique frequency bins
   Varying the spectrum in frequency bands randomly in range of −6 to 6 dB, and multiplying the amplitude by the square root of its direct-to-total ratio
   Associating the processed pink noise sequence with the virtual loudspeaker nearest to the direction of the source. Alternatively, it could be amplitude panned with the nearest virtual loudspeakers, if the virtual loudspeaker spacing is not dense
For the ambient part:
   For each virtual loudspeaker, generating a 2048 sample pink noise sequence, windowing them with a square-root Hanning window, and transforming them with FFT to 1025 unique frequency bins
   Varying the spectrum in frequency bands randomly in range of −6 to 6 dB, and multiplying its amplitude by the square root of (ambience-to-total ratio/num virtual loudspeakers)

The 1025-bin frequency domain representation is an example. Other resolutions and numbers of frequency bins can be used in other examples.

The variation of the spectrum of the direct and ambient sounds by +−6 dB is used to make the virtual sound scenes less ideal. This helps to prevent the machine learning model from falsely learning to expect certain spectra for the sources. In some examples this helps to prevent the machine learning model from falsely assuming excessively ideal ambience distributions, or from making other similar assumptions that are not guaranteed in natural sound scenes.

In some examples a large number of spatial sound distributions could be determined. The number of spatial sound distributions 303 that are determined can be sufficient to enable training of a machine learning model. In some examples around 100 000 spatial sound distributions 303 could be determined. In some examples more than 100 000 spatial sound distributions 303 could be determined.

Once the spatial sound distributions have been determined the spatial sound distributions 303 are provided as an input to generate both first capture data and second capture data for a machine learning model.

At block 305 the first capture data 307 is obtained. The first capture data 307 represents what a target device would capture for a given spatial sound distribution 303.

In the example of FIG. 3 the spatial sound distributions 303 can comprise one or more virtual spatial sound distributions 303. In such examples microphone array information 113 is obtained and used to obtain the first capture data 307. The microphone array information 113 comprises information relating to a microphone array of the target device. The microphone array information 113 could comprise information relating to the number of microphones, the relative positions of microphones, the types of microphones within the array, impulse responses for the microphone array, transfer functions or steering vectors for the microphone array, recorded microphone array responses to directional sounds, sound recordings, simulated microphone array responses or recordings and/or any other suitable information.

In this example the microphone array information 113 can comprise a set of impulse responses for a set of directions in relation to the target device. The set of directions in relation to the target device can be the same as the set of virtual loudspeaker directions that are used to generate the sound scenes for the virtual spatial sound distributions 303, since such responses are used to make the virtual loudspeaker capturing.

The set of impulse responses can then be converted to the same frequency bin resolutions as the virtual spatial sound distributions 303. In this example the set of impulse responses are converted to the 1025-bin frequency resolution. The process of converting the impulse responses to the 1025-frequency bin resolution can comprise:
1) truncating the impulse responses to length of 2048 samples,
2) windowing out the impulse response tail smoothly to avoid an abrupt offset,
3) circularly rotating the set of impulse responses so that their average group delay is near to zero, and
4) converting the result to 1025 unique frequency bins using FFT.

The result is referred to as microphone array transfer functions H(b, c, i) where b is the frequency bin, c is the virtual loudspeaker channel and i is the array microphone index.

The first capture data 307 can be obtained by using the microphone array information 113 to process the spatial sound distributions 303. The first capture data 307 can comprise signals that represent microphone signals as if the spatial sound distributions 303 were captured by the microphone array of the target device. The first capture data 307 can be provided in any suitable format.

Any suitable process can be used to convert the spatial sound distributions 303 into the first capture data 307. In some examples the microphone array information 113 can be used to convert the spatial sound distributions 303 into virtual recordings. In some examples this can be done for each of the spatial sound distributions 303 by

$$s ( b , i ) = {\sum }_{c = 1}^{{N}_{c}} H ( b , c , i ) v ( b , c )$$

where s(b, i) are the virtual recording signals, and v(b, c) are the virtual loudspeaker signals and N_{c} is the number of virtual loudspeaker channels. The virtual recording signals s(b, i) provide the first capture data 307.

At block 309 the input data 311 for the machine learning model is determined. The determining of the input data 311 can comprise processing the first capture data 307 into a format that is suitable for use as an input to the machine learning model. For example, if not already in a frequency domain, the capture data 307 can be transformed from the time domain to the frequency domain and then checked for correlations for different microphones within the microphone array at different frequencies to provide the input data 311 for the machine learning model. In some examples, if the first capture data 307 is already in a suitable form, then the block 309 could be omitted.

In this example where the first capture data 307 comprises virtual recording signals s(b, i) the process of determining the input data comprises receiving the first capture data 307 and converting the virtual recording signals s(b, i) into a format suitable for an input for the machine learning model. The suitable format can be determined by the structure of the machine learning model or by any other suitable factors.

In some examples the virtual recording signals s(b, i) can be converted into a data array. In this example the data array can have a size of 64×48×3. The data format can be denoted as m(d, l, c) where d=1, . . . , 64 is a delay index, l=1, . . . , 48 is the frequency index and c=1, 2, 3 is the channel index. Other sizes can be used for the data array in other examples of the disclosure.

The first channel m(d, l, 1) of the input data can be configured to contain normalized inter-microphone cross correlation data based on the virtual recording signals s(b, i).

The normalized inter-microphone cross correlation data can be formulated using the following process or any other suitable process. This process can be used for each of the spatial sound distributions independently.

The virtual recording signals s(b, i) have 1025 unique frequency bins where b=1, . . . , 1025 is the bin index and i is the channel index. The values that i can have are determined by the number of microphones within the microphone arrays. In this example where the microphone array comprises two microphones i=1, 2

The first channel comprising normalized inter-microphone cross correlation data is then:

$$m ( d , l , 1 ) = \frac{Real \{ {\sum }_{b = {b}_{low} ( l )}^{{b}_{high} ( l )} s ( b , 1 ) s * ( b , 2 ) {e}^{j 2 π * freq ( b ) * dly ( d )} \}}{\sqrt{( {\sum }_{b = {b}_{low} ( l )}^{{b}_{high} ( l )} {\vert s ( b , 1 ) \vert}^{2} ) ( {\sum }_{b = {b}_{low} ( l )}^{{b}_{high} ( l )} {\vert s ( b , 2 ) \vert}^{2 )}}} \qquad ( l )$$

Where Real{ } denotes an operation preserving only the real part, b_{low}(l) and b_{high}(l) are bin limits for frequency index l, freq(b) is the center frequency of bin b and dly(d) is the delay value corresponding to the delay index d, and j is the imaginary unit. The set of delay-values dly(d) can be determined such that they span a reasonable range given the spacing of microphones within the microphone array. For example, if the target device is a mobile phone being used in a landscape orientation then the delays could be spaced regularly within the range between −0.7 and 0.7 milliseconds.

In this example, the bin limits b_{low}(l) and b_{high}(l) approximate the Bark bands frequency resolution so that two consecutive frequency indices together form one Bark band. Therefore, the number of these bands l is 48.

The second channel m(d, l, 2) of the input data comprises delay reference values so that

$$m ( d , l , 2 ) = n orm ( dly ( d ) )$$

where norm( ) is a function that normalizes the channel mean to zero and standard deviation to 1.

The third channel m(d, l, 3) of the input data comprises frequency reference values so that

$$m ( d , l , 3 ) = norm ( floor ( \frac{l}{2} ) )$$

where floor( ) function rounds to the previous integer value. The frequency reference values therefore relate the 48 frequency indices I from a data array m(d, l, c) to the 24 Bark bands, which are the bands where the spatial metadata is actually estimated. The data arrays m(d, l, c) provide the input data 311 that can then be provided for training the machine learning model.

The spatial sound distributions 303 are also used, at block 313, to obtain second capture data 315. The second capture data 315 comprises information of the spatial properties of the spatial sound distributions 303.

Any suitable process can be used to obtain the second capture data 315. The process that is used to obtain the second capture data 315 can comprise a process that is not feasible for the target device. In some examples the second capture data 315 can be determined by using an ideal, or substantially ideal, reference virtual microphone array to process the spatial sound distributions 303, or by any other suitable reference capture method. The ideal (or reference) microphone array could have very few or no errors in the capturing of the spatial sound distributions 303 compared to what is achievable with known means with any practical array, including the microphone array of the target device. In some examples the ideal (or reference) virtual microphone array could comprise ideal Ambisonic capturing of any order. This provides for an improved capture of the spatial sound distributions 303 compared to what is achievable with known means with the microphone array of the target device.

In other examples a virtual microphone array (such as, simulated capturing using idealized or reference array responses) need not be used. For instance, an algorithm or other process could be used to convert the spatial sound distributions 303 into the second capture data 315. For example, if a spatial sound distribution would define only one or two prominent sources, their known directions could directly provide the directional information within the second capture data, without using a virtual microphone array. Similarly, a direction parameter could be determined as a vector averaging multiple directional sound components within the spatial sound distributions.

The second capture data 315 therefore represent the spatial metadata that could be captured by an ideal, or substantially ideal, reference microphone array for a given spatial sound distribution, or by any other suitable reference capture method. The reference microphone array can be a real or virtual microphone array. This can be referred to as reference spatial metadata. The spatial metadata can be in any suitable form that expresses the spatial features of the spatial sound distributions. For example, the spatial metadata could comprise one or more of the following: direction parameters, direct-to-total ratio parameters, spatial coherence parameters (indicating coherent sound at surrounding directions), spread coherence parameters (indicating coherent sound at a spatial arc or area), direction vector values and any other suitable parameters expressing the spatial properties of the spatial sound distributions.

An example process that can be used to obtain the reference spatial metadata from the spatial sound distributions can be as follows. In this example the spatial metadata parameters can comprise a sound direction and directionality (a parameter indicating how directional or non-directional/ambient the sound is). This could be a direction-of-arriving-sound and a direct-to-total ratio parameter. The parameters of the spatial metadata can be provided in frequency bands. Other parameters could be used in other examples of the disclosure.

The direction-of-arriving sound and the direct-to-total ratio parameters can be determined by idealized (or reference) capturing of the spatial sound distributions 303 with an assumed ideal (or non-biased) first-order Ambisonic microphone array. Such a capture is obtained by

$${x}_{f} ( b , i ) = {\sum }_{c = 1}^{{N}_{c}} a ( c , i ) v ( b , c )$$

where x_{ƒ}(b, i) is the virtually captured Ambisonic signal, i=1, . . . , 4 is the Amibisonic channel (component) and a(c, i) is the Ambisonic encoding coefficient for the direction of virtual loudspeaker c and Ambisonic channel (component) i.

The Ambisonic microphone array capturing is highly idealistic compared to the microphone arrays provided within typical target devices such as mobile telephones or other handset type devices. The Ambisonic microphone array can obtain the spatial information from a spatial sound distribution in a wider frequency range and with more accuracy compared to using known means with the microphone arrays available within the typical target devices.

The Ambisonic microphone array provides a reference capture arrangement for determining the target spatial information that the machine learning model is being trained to estimate. Other capture arrangements could be used in other examples of the disclosure.

In this example the formulas of the Directional Audio Coding (DirAC) capture method are used. This capture method is known to be able to produce, based on the first order signals, the direction and a direct-to-total energy ratio parameters that represent perceptually well a captured sound scene. It is to be appreciated that, even if the spatial sound distributions 303 comprise sounds from a plurality of simultaneous directions, the spatial sound distributions 303 can still be in most practical spatial sound situations sufficiently accurately represented by a single average direction and a direct-to-total energy ratio in frequency bands. In other examples a plurality of simultaneous directions of arrival within a given frequency band can be defined and the corresponding ratio parameters can be determined accordingly. Having a plurality of simultaneous direction estimates can provide perceptual benefit in some specific situations of spatial sound rendering such as two talkers talking simultaneously at different directions in a dry acoustic environment.

As mention above, the virtually captured first order Ambisonic signals were denoted x_{ƒ}(b, i) where b=1, . . . , 1025 is the frequency bin index and i=1, . . . , 4 is the channel index in the typical W,Y,Z,X channel ordering. The direction parameter, for a frequency band k, is then determined by first determining the intensity of an energy by

$${I}_{x} ( k ) = {\sum }_{b = {b}_{low} ( k )}^{{b}_{high} ( k )} r eal ( {x}_{f} ( b , 1 ) {x}_{f}^{*} ( b , 4 ) )$$

$${I}_{y} ( k ) = {\sum }_{b = {b}_{low} ( k )}^{{b}_{high} ( k )} r eal ( {x}_{f} ( b , 1 ) {x}_{f}^{*} ( b , 2 ) )$$

$${E}_{f} ( k ) = \frac{1}{2} {\sum }_{b = {b}_{lowJ} ( k )}^{{b}_{high} ( k )} {\sum }_{i = 1}^{4} {\vert {x}_{f} ( b , i ) \vert}^{2}$$

Where b_{low}(k) and b_{high}(k) were the bin limits for band k so that the bands k=1, . . . , 24 approximate the Bark frequency resolution. The estimated direction and ratio values are then

$${azi}_{ref} ( k ) = a tan 2 ( {I}_{y} ( k ) , \vert {I}_{x} ( k ) \vert )$$

where the x-axis absolute value causes in our example the azimuth values to be on the front −90 . . . 90 degrees only, and

$${ratio}_{ref} ( k ) = \frac{\sqrt{{\vert {I}_{x} ( k ) \vert}^{2} + {\vert {I}_{y} ( k ) \vert}^{2}}}{{E}_{f} ( k )}$$

The values azi_{ref}(k) and ratio_{ref}(k) form the second capture data 315 that comprises reference spatial metadata. In this example, the limitation to front −90 . . . 90 degrees, and only to a horizontal plane relates to the specified use case example in which the target device was assumed to be a mobile phone with two microphones at edges in a landscape orientation. For such devices it is not feasible to determine elevations or to discriminate between front and rear directions. Therefore, the ideal (reference) spatial metadata is formed only for the horizontal plane and so that the rear directions are mirrored to the front side. Consequently, the machine learning model will learn to mirror any rear sounds to front in a similar fashion. If the target device comprises three or more microphones this enables discrimination between front and rear directions. In such examples the spatial metadata could also comprise the rear directions. Similarly, if the microphone array of the target device also supported elevation analysis, the direction parameter of the ideal (reference) metadata could also comprise elevation.

At block 317 reference data 319 for the machine learning model is determined. The reference data 319 is determined by processing the second capture data 315. The processing of the second capture data 315 can comprise any processing that converts the second capture data 315 into a format that is suitable for use as an reference data for the machine learning model. In some examples the second capture data 315 can be processed so that the reference data 319 comprises no, or substantially no, discontinuities. In some examples, when the second capture data 315 is already in a suitable form as the reference data for the machine learning model, then block 317 is not needed.

In examples of the disclosure the process of determining the reference data 319 for the machine learning model can comprise receiving the second capture data 315 comprising the reference spatial metadata for each of the spatial sound distributions 303.

The suitable form of the reference data 319 will be determined by the structure of the machine learning model. In this example the output of the machine learning model can be configured to comprise a data array comprising 24×2 data points. The machine learning model can be structured this way so that the output comprises 24 frequency bands and two parameters for each frequency band.

In some examples the direction value and the energy ratio value could be used as the two parameters for each of the frequency bands within the reference data 319. In other examples the direction values and the energy ratio values could be used in a converted form. The use of the converted form can mutually harmonize the output parameters.

In some examples the reference data 319 that uses a converted form of the direction values and the energy ratio values can be given by:

$$ref ( k , 1 ) = cos ( {azi}_{ref} ( k ) ) f ( {ratio}_{ref} ( k ) )$$

$$ref ( k , 2 ) = sin ( {azi}_{ref} ( k ) ) f ( {ratio}_{ref} ( k ) )$$

$$where$$

$$f ( ratio ( k ) ) = 1 - \sqrt{1 - {( ratio ( k ) )}^{2}}$$

Where ref(k, p), is the reference data 319, k=1, . . . , 24, p=1, 2, azi_{ref}(k) is the azimuth direction and ratio_{ref}(k) is the energy ratio.

In such examples the reference data comprises a vector pointing towards the azimuth direction, where the vector length is a function of the energy ratio parameter. In this example the energy ratio parameter is not used directly as the vector length. The purpose of using the function ƒ( ) is that large ratios (such as 0.9) can be mapped to smaller values. This which means that, during training of the machine learning model, a particular difference of the estimated energy ratio causes a larger error at the high ratio range than at the low ratio range.

This configuration can be beneficial because human hearing is known to perceive errors at the energy ratio parameter more at the high ratio range when used for spatial audio rendering.

The inverse function corresponding to ƒ( ) is

$${f}^{- 1} ( α ) = \sqrt{1 - {( 1 - α )}^{2}}$$

This function may be used during inference to remap the estimated ratio-related parameter to the actual energy ratio estimate. In the above notation the energy ratio and azimuth values are only dependent upon frequency. It is to be appreciated that in implementations of the example the values typically also vary as a function of time.

The above example only deals with front azimuthal directions. In some examples the microphone array could support other directions. In such examples the machine learning model can be configured to comprise also rear angles and/or elevation angles. In such cases the reference data 319 would have different dimensions to that provided in the previous example. For example, the reference data 319 could have dimensions of 24×3. In such examples the input data 311 would also be in a format that allows for the use of the elevation angle (rear directions are already supported in the 24×2 format). For example, the input data 311 could comprise a data array having dimensions 64×48×4 or 64×48×5, where first two or three layers would contain inter-microphone correlation data from different pairs of a target device having more than two microphones, and the last two layers would have the delay and frequency maps as described in the foregoing.

At block 321 the input data 311 and the reference data 319 are used to train the machine learning model. Any suitable process can be used to train the machine learning model. The machine learning model is trained to use the input data 311 to estimate, or approximate, the reference data 319. The machine learning model is trained to provide the reference data 319, or substantially the reference data 319 as an output.

If the reference data 319 was composed of the reference spatial metadata in a converted form, such as vectors, then in some examples the vectors can be converted back to the form where the reference spatial metadata is defined, or into any other form. For example, the vector directions provide the direction parameters, and the vector lengths, processed with function ƒ⁻¹( ) provide the ratio parameters. However, such conversion can be used when the trained network is applied at the target device, whereas in the machine learning model training stage such conversion might not be needed.

In examples of the disclosure the input data 311 and reference data 319 for each of the Nₛ spatial sound distributions 303 are used to train the machine learning model. In examples of the disclosure the input data 311 comprises Nₛ input data arrays of size 64×48×3 comprising delay-correlation data at the first channel and the delay and frequency maps at the other two channels. The reference data 319 comprises Nₛ reference values of size 24×2 comprising a vector expressing the direction and energy ratio for each frequency band.

The training process used for the machine learning model could be the Adam optimiser with an initial learning rate of 0.001 and a mean-square-error loss function. Other processes and/or optimisers, such as any other Stochastic Gradient Descent (SGD) variant, could be used in other examples of the disclosure.

Once the training of the machine learning model has been completed a trained machine learning model 115 is provided as an output. In some examples the output could comprise parameters for a trained machine learning model that can be provided to a target device and/or otherwise accessed by a target device. The parameters could comprise weights, multipliers and any other suitable parameters for the trained machine learning model. In other examples, the trained machine learning model is converted to a sequence of program code operations that can be compiled to be used on the target device, or any other means to deploy the trained machine learning model to the target device to be used.

It is to be appreciated that variations to the method shown in FIG. 3 can be used in examples of the disclosure. For instance, in some examples the spatial sound distributions 303 can comprise real sound distributions. In such examples the spatial sound distributions could be played back by a plurality of loudspeakers and captured by a microphone array associated with the target device. In such examples the microphone array information 113 does not need to be used to obtain the first capture data 307 because the captured microphone signals could be used instead.

The training of the machine learning model can be performed by a manufacturer of target devices or by a provider of services to target devices or by any other entity. The trained machine learning model 115 can then be provided to target devices or can be stored in a location that can be accessed by the target devices. The trained machine learning model can then be used to estimate spatial metadata when the target device is being used to capture spatial audio. In some examples the data provided as an output by the machine learning model can be processed to provide the spatial metadata, for example the network output data could be provided as an output which can then be converted to spatial metadata. The use of the trained machine learning model can enable accurate spatial audio to be provided even when a sub-optimal microphone array is used to capture the spatial audio.

Training the machine learning model externally to the target devices provides several advantages. For example, it enables the same trained machine learning model to be provided to a plurality of target devices. For instance, a manufacturer of target devices could install the trained machine learning model in all of a given model of target device. It also allows a large amount of computing power to be used to train the machine learning model. Such levels of computing power might not be available in the target devices.

In examples of the disclosure the methods of FIGS. 2 and 3 could be implemented using a single apparatus 101 or by using a plurality of apparatus 101. Where a plurality of apparatus 101 are used the plurality of apparatus 101 could be distributed within a cloud or other suitable network. In some examples different apparatus 101 could perform different parts of the methods. For instance, the apparatus 101 could be configured to determine the input data 311 and the reference data 319 and a second, different apparatus 101 could be used to train the machine learning model.

FIG. 4 shows an example machine learning model structure 109 that could be used in examples of the disclosure. In this example the machine learning model is a neural network. Other types of machine learning model could be used in other examples of the disclosure.

The machine learning model structure 109 can be stored in the memory 105 of an apparatus 101 and used for training the machine learning model. In some examples the machine learning model structure 109 can also be stored in the memory of target devices so as to enable the machine learning model to be used within the target device.

In the example of FIG. 4 the machine learning model is a residual convolutional neural network comprising a plurality of layers as shown in FIG. 4. The example machine learning model structure 109 comprises an input layer 401, input 2D convolution layer 403, a plurality of residual neural network (resnet) layers 405, an output 2D convolution layer 407, and a regression output layer 409. In the example of FIG. 4 the machine learning model structure 109 comprises eight resnet layers 405. Other numbers of resnet layers 405 could be used in other examples of the disclosure.

The input layer 401 is configured to input an array of data into the neural network. The array of data can comprise data sets configured in arrays comprising a delay value on a first axis, a frequency value on another axis and a plurality of channels. In some examples the data array can be configured to comprise 64 delay values, 48 frequency values and 3 channels. This enables a 64×48×3 size array of data to be input into the neural network.

In the example of FIG. 4, the first of the three channels can be defined to comprise real-valued inter-microphone correlation values at a set of delays and frequency ranges. This first channel is the only one of the three channels that comprises signal-dependent data. The second channel comprises delay values for the 64 delays, and the third channel comprises frequency values for the 48 frequencies. The delay and frequency values allow the subsequent convolutional filters of the neural network to learn to become, at least partly, location specific. Further details and generation of such input data arrays is provided further below.

The input 2D convolution layer 403 is configured to expand the channels of the input data array into a format that is more suitable for the subsequent layers of the neural network. In the example of FIG. 4 the input 2D convolution layer 403 comprises 64 1×1×3 filters without a nonlinearity. This can expand the channels of the input data array into a 64×48×64 array.

In the example of FIG. 4 the neural network comprises eight resnet layers 405. FIG. 5 shows the structure of an example resnet layer 405 in more detail. Each of the resnet layers 405 within the neural network can have the same, or substantially the same, structure.

The final resnet layer 405 is coupled to the output 2D convolution layer 407. The output 2D convolution layer 407 is configured to convert the output data into a suitable format. In some examples the output 2D convolution layer 407 can be configured to provide the output data in a 24×2, form or a 1×24×2 form or any other suitable form.

The output of the output 2D convolution layer 407 is provided to the regression output layer 409. The regression output layer 409 can be configured to perform a mean square error formulation, or any other suitable error formulation, of the data with respect to reference data. This formulation can be performed during training of the neural network.

FIG. 5 shows the structure of an example resnet layer 405. This could be used within a neural network such as the neural network shown in FIG. 4. Other configurations of resnet layers 405 could be used in other examples of the disclosure.

The resnet layer 405 comprises a sequence of layers. The sequence of layers comprises a batch normalization layer 501, a rectified linear unit (ReLu) layer 503 and a 2D convolution layer 505. In the example of FIG. 4 two such sequences of layers are provided where each of the sequences comprises a batch normalization layer 501, a rectified linear unit (ReLu) layer 503 and a 2D convolution layer 505. The two sequences of layers are provided in a cascade configuration so that the output of the first sequence of layers is provided as an input to the second sequence of layers.

It is to be appreciated that variations of these layers could be used in examples of the disclosure. For instance, in some examples the batch normalization layer 501 could be replaced with population statistics or could be folded to a previous operation or to a following operation.

The ReLu layer 503 can comprise a rectified linear unit or can be replaced by any means that is configured to provide non-linearity to the neural network. Where the neural network comprises a large number of ReLu layers 503 and convolutions layers 505 these can combine to form an approximation of the function that the neural network is being trained to estimate.

In the example of FIG. 5 the resnet layer 405 also comprises a convolution layer bypass 507. This can be an optional feature and need not be provided in all examples of layers 405. In examples where the convolution layers 505 have a stride length of one then the layer bypass 507 could be only a bypass without any convolutions. In examples where the convolution layers 505 have a stride length that is greater than one then the convolution is provided in the bypass layer so as to provide matching of dimensions of the data within the sum layer 509. The convolutional bypass can also be used if the convolutional layers 505 have a different output channel count compared to its input channel count in order to match input and output channel counts. The bypass may not use any nonlinearity, such as ReLU.

The example resnet layer 405 also comprises a sum layer 509. The sum layer 509 can be configured to sum outputs from the sequence of layers and from the convolutional layer bypass 507. Note that other means of combining the information could be used such as a channel-wise concatenation operation.

Any suitable hyperparameters can be used within the example neural network of FIGS. 4 and 5. The hyperparameters can comprise parameters of the neural network that are set before the neural network is trained. Examples of hyperparameters that could be used in an example neural network are provided in the following table. In this example the hyperparameters comprise kernel sizes, strides lengths and number of filters for each of the convolution layers 505 in each of the resnet layers 405. Other hyperparameters could be used in other examples of the disclosure.

| | Kernel | | Number of |
|---|---|---|---|
| Layer | size | Stride | filters |
| Input 2D convolution | 1 × 1 | (1, 1) | 64 |
| ResNet 1, conv 1 | 3 × 3 | (1, 1) | 64 |
| ResNet 1, conv 2 | 3 × 3 | (1, 1) | 64 |
| ResNet 2, conv 1 | 3 × 3 | (1, 1) | 64 |
| ResNet 2, conv 2 | 3 × 3 | (2, 1) | 64 |
| ResNet 3, conv 1 | 3 × 3 | (1, 1) | 64 |
| ResNet 3, conv 2 | 3 × 3 | (1, 1) | 64 |
| ResNet 4, conv 1 | 3 × 3 | (1, 1) | 64 |
| ResNet 4, conv 2 | 3 × 3 | (2, 2) | 64 |
| ResNet 5, conv 1 | 3 × 3 | (1, 1) | 64 |
| ResNet 5, conv 2 | 3 × 3 | (2, 1) | 64 |
| ResNet 6, conv 1 | 3 × 3 | (1, 1) | 64 |
| ResNet 6, conv 2 | 3 × 3 | (1, 1) | 64 |
| ResNet 7, conv 1 | 3 × 3 | (1, 1) | 64 |
| ResNet 7, conv 2 | 3 × 3 | (2, 1) | 64 |
| ResNet 8, conv 1 | 3 × 3 | (1, 1) | 64 |
| ResNet 8, conv 2 | 3 × 3 | (2, 1) | 64 |
| Output 2D convolution | 2 × 1 | (2, 1) | 2 |

FIG. 6 shows a visualization of data 601 that can be used in examples of the disclosure. The data 601 can be the data comprised within the first channel comprising normalized inter-microphone cross correlation data m(d, l, 1). A delay index is provided on the vertical axis and a frequency index is provided on the horizontal axis.

This data 601 can be obtained from a spatial sound distribution 303 comprising one prominent sound source at an angle corresponding to a delay. The spatial sound distribution 303 also comprises some interfering sounds or ambience that affects the maximum correlation data at some frequencies.

In the above described examples the machine learning model can be trained for use in a target device where the target device comprises two microphones at edges, or near to edges, of the target device. For example, a mobile telephone could comprise a first microphone positioned close to a first edge of the device and a second microphone positioned close to an opposing edge of the device. For such target devices, an azimuth value for an audio signal can be determined based on correlation values at different delays. However, in such target devices, it might not be possible to differentiate between sounds from the front of the target device and sounds from the rear of the target device. For instance, sounds from 80 degrees to the right of the target device generate similar inter-microphone characteristics to sounds at 100 degrees to the right of the target device. Similarly, elevations at the same cone-of-confusion cause similar measurable inter-microphone characteristics.

In order to address this issue, in examples of the disclosure where the machine learning model is being trained for use in a target device comprising two microphones, the machine learning model can be trained to only detect sound directions within an arc of −90 to 90 degrees. Any sound sources that are at rear directions or at elevations can be mapped to corresponding directions within the cone of confusion.

Restriction the directions to between −90 and 90 degrees will limit the spatial audio capture. However, these limitations can still provide sufficient quality. For example, if the spatial audio is to be used for binaural audio capturing that does not support rotation of the listeners head then spatial errors within the cone of confusion will typically not be perceived as distracting, or even noticed, if a reference is not available for comparison.

Also in many cases all of the sound sources of interest would be on the same side of the audio capture device. For example, if the audio capture device is used for teleconferencing or used to capture video images and corresponding audio, then the sources of interest are typically only or mostly at the camera side of the device. Furthermore, in typical audio environments, the majority of the audio sources of interest are near the horizontal plane, and so support for elevation is not always needed.

In some examples the microphone array of the target device could comprise more than two microphones. This could enable additional spatial information to be obtained by the microphone array.

For instance, the target device could comprise a mobile telephone comprising a first microphone positioned close to a first edge of the device and a second microphone positioned close to an opposing edge of the device and a third microphone positioned close to the main camera. For such target devices a plurality of delay-correlation maps can be formulated. For example, correlation maps between all microphone pairs could be determined and the input data m(d, l, c) for the machine learning model would then comprise more than three layers. In such cases the machine learning model could be trained in all 360 degrees in the in the horizontal plane (as opposed to only between −90 and 90 degrees), as there is now information to determine if the sounds arrive from the front or rear of the target device.

In other examples the left-right microphone pair could be used to determine the angle value between −90 and 90 degrees. A front-back microphone pair (for example, the microphone nearest the camera and the nearest edge microphone) could be used for determining a binary choice in frequency bands if the sound is arriving more likely from the front or rear of the device. Then the azimuth value determined between −90 and 90 degrees could be mirrored to rear, when necessary, therefore enabling determination of azimuth in 360 degrees. The front-back determination could be provided by a second trained machine learning model, or by other means not using machine learning.

In other examples the target device could comprise more than three microphones and some of the microphones could be provided in vertically different positions. In such examples, there could be a plurality of inter-microphone correlation maps, and the training of the machine learning model could also include elevation angles.

The input data 311 can also comprise information relating to other parameters than correlations, delay indices and frequency indices, such as microphone energies or any other suitable information. The information relating to microphone energies could be used in examples where the microphone array of the target device comprises directional microphones. This could also be used where the target device causes shadowing and so provides information indicating the sound directions. The shadowing could affect a subset of the frequency bands. For example, the shadowing could affect only the higher frequencies.

In the above examples the first capture data 307 was converted into a data array comprising normalized inter-microphone correlation values at different delays and frequencies. This was provided as input data 311 for the machine learning model. It is to be appreciated that other formats of input data 311 can be used in other examples of the disclosure. For instance, in some examples a normalized complex-valued correlation vector can be formulated as used as the input data 311. The normalized complex-valued correlation vector could comprise the same information as the normalized inter-microphone correlation values although not in a form that can be visualized straightforwardly. In such examples the machine learning model could be designed to estimate the spatial metadata based on the normalized complex-valued correlation vector. It is to be appreciated that the output of the machine learning model could be in a different format and could be processed to provide the spatial metadata. For instance, the machine learning model could provide network output data as an output and this could be converted into spatial metadata.

In other examples the input data 311 could comprise microphone signals in the frequency domain. In such examples the machine learning model would be designed accordingly.

It also to be appreciated that other examples of the disclosure could use different machine learning models to the examples described herein. For instance, the dimensions of the machine learning model, the number of layers within the machine learning model, used layer types, and other parameters could be different in other examples of the disclosure. Also dimensions of the input data 311 and output data may be different in other examples of the disclosure. For instance, an audio encoder could use only five frequency bands for the spatial parameters instead of the 24 Bark bands, and so the machine learning network could be designed to provide spatial metadata only at five bands.

In the above described examples the trained machine learning model is configured to provide spatial metadata as an output or to provide data, such as network output data, that can be converted to the spatial metadata. In the above described examples the spatial metadata comprise a direction parameter and an energy ratio parameter in frequency bands. Other formats can be used for the output of the machine learning model and/or the spatial metadata.

Examples of the disclosure therefore provide a trained machine learning model that can be used for spatial audio capturing. The training of the machine learning model can provide for robust determination of the spatial metadata for any suitable target device. Acoustic features of the target device can be taken into account in the design and training of the machine learning model. This can also allow for optimized, or substantially optimized fitting of the spatial audio capturing to new target devices without need of expert tuning

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not. Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. An apparatus comprising:
at least one processor; and
at least one non-transitory memory that, when executed with the at least one processor, cause the apparatus to:
obtain first capture data for a machine learning model where the first capture data is related to a plurality of spatial sound distributions and where the first capture data relates to a target device configured to obtain at least two microphone signals;
obtain second capture data for the machine learning model where the second capture data is obtained using the same plurality of spatial sound distributions and where the second capture data comprises information indicative of spatial properties of the plurality of spatial sound distributions and the second capture data is obtained using a reference capture method; and
train the machine learning model to estimate the second capture data based on the first capture data.

2. An apparatus as claimed in claim 1, wherein the instructions, when executed with the at least one processor, cause the apparatus to train the machine learning model for use in processing microphone signals obtained with the target device.

3. An apparatus as claimed in claim 1, wherein the machine learning model comprises a neural network.

4. An apparatus as claimed in claim 1, wherein the spatial sound distributions comprise a sound scene comprising a plurality of sound positions and corresponding audio signals for the plurality of sound positions.

5. An apparatus as claimed in claim 4, wherein the spatial sound distributions used to obtain the first capture data and the second capture data comprise virtual sound distributions.

6. An apparatus as claimed in claim 4, wherein the spatial sound distributions are produced with two or more loudspeakers.

7. An apparatus as claimed in claim 1, wherein the spatial sound distributions comprise a parametric representation of a sound scene.

8. An apparatus as claimed in claim 1, wherein the instructions, when executed with the at least one processor, obtain the information indicative of spatial properties of the plurality of spatial sound distributions in a plurality of frequency bands.

9. An apparatus as claimed in claim 1, wherein the instructions, when executed with the at least one processor, cause the obtained first capture data to cause the apparatus to:
obtain information relating to a microphone array of the target device; and
use the information relating to the microphone array to process a plurality of spatial sound distributions to obtain first capture data.

10. An apparatus as claimed in claim 9, wherein the instructions, when executed with the at least one processor, cause the apparatus to process the first capture data into a format that is suitable for use as an input to the machine learning model.

11. An apparatus as claimed in claim 1, wherein the instructions, when executed with the at least one processor, cause the obtained second capture data to cause the apparatus to use the one or more spatial sound distributions and a reference microphone array to determine reference spatial metadata for the one or more sound scenes.

12. An apparatus as claimed in claim 1, wherein the instructions, when executed with the at least one processor, cause the apparatus to train the machine learning model to provide spatial metadata as an output.

13. An apparatus as claimed in claim 12, wherein the spatial metadata comprises, for one or more frequency sub-bands, information indicative of:
a sound direction; and
sound directionality.

14. An apparatus as claimed in claim 1, wherein the target device comprises a mobile telephone.

15. A method comprising:
obtaining first capture data for a machine learning model where the first capture data is related to a plurality of spatial sound distributions and where the first capture data relates to a target device configured to obtain at least two microphone signals;
obtaining second capture data for the machine learning model where the second capture data is obtained using the same plurality of spatial sound distributions and where the second capture data comprises information indicative of spatial properties of the plurality of spatial sound distributions and the second capture data is obtained using a reference capture method; and
training the machine learning model to estimate the second capture data based on the first capture data.

16. A method as claimed in claim 15, wherein the spatial sound distributions comprise a sound scene comprising a plurality of sound positions and corresponding audio signals for the plurality of sound positions.

17. A non-transitory program storage device readable with an apparatus, tangibly embodying a program of instructions executable with the apparatus for performing:
obtaining first capture data for a machine learning model where the first capture data is related to a plurality of spatial sound distributions and where the first capture data relates to a target device configured to obtain at least two microphone signals;
obtaining second capture data for the machine learning model where the second capture data is obtained using the same plurality of spatial sound distributions and where the second capture data comprises information indicative of spatial properties of the plurality of spatial sound distributions and the second capture data is obtained using a reference capture method; and
training the machine learning model to estimate the second capture data based on the first capture data.

18-20. (canceled)

21. A method as claimed in claim 16, wherein the spatial sound distributions used to obtain the first capture data and the second capture data comprise virtual sound distributions.

22. A method as claimed in claim 16, wherein the spatial sound distributions are produced with two or more loudspeakers.

23. A method as claimed in claim 15, wherein the spatial sound distributions comprise a parametric representation of a sound scene.
